(19) United States
(12) Patent Application Publication
(10) Pub. No.: US 2014/0344019 A1
(43) Pub. Date: Nov. 20, 2014

(54) CUSTOMER CENTRIC SYSTEM FOR PREDICTING THE DEMAND FOR PURCHASE LOAN PRODUCTS

(71) Applicant: Bank of America Corporation, Charlotte, NC (US)

(72) Inventor: Jason Thalken, Austin, TX (US)

(21) Appl. No.: 13/894,168

(22) Filed: May 14, 2013

(51) Int. Cl. G06Q 30/02

(52) U.S. Cl. CPC G06Q 30/0202; G06Q 40/025
USPC 705/7.31

(57) ABSTRACT

Disclosed is a customer centric system for predicting the demand for purchase loan products. The system typically includes a customer profile database storing a plurality of customer profiles reflecting a plurality of hypothetical shopping customers, a purchase loan product profile database storing a plurality of competing purchase loan product profiles reflecting a plurality of hypothetical competing purchase loan products, and a prediction rules module storing a plurality of rules for determining how each hypothetical shopping customer makes a purchase loan decision. The system also typically includes a prediction module configured for predicting the demand volume of shopping customers for a purchase loan product during a predetermined period of time by simulating the purchase loan decision of each hypothetical shopping customer and predicting the demand volume of non-shopping customers for the purchase loan product during the predetermined period of time.

### FIELD OF THE INVENTION

The present invention embraces a customer centric system for predicting the demand for purchase loan products. The system typically includes a processor and a memory storing a customer profile database, a purchase loan product profile database, a prediction rules module, and a prediction module.

### BACKGROUND

Financial institutions typically use product-level elasticity models to predict how a price change (e.g., an interest rate change) of a loan product will affect the demand for that loan product. These product-level elasticity models are typically built using regression modeling of historical data to try to predict how a market will react to a loan product's price change.

Significant error has been observed between the predictions of such product-level elasticity models and the actual observed demand of a loan product. Accordingly, a need exists for an improved way of predicting the demand of loan products.

### SUMMARY

In one aspect, the present invention embraces a method of predicting the demand of a first purchase loan product provided by a first financial institution. The present invention also embraces a system configured for performing one or more of the steps of the method.

The method typically includes storing a plurality of customer profiles reflecting a plurality of hypothetical shopping customers. The hypothetical customers typically reflect the makeup of customers expected to be shopping for purchase loan products during a predetermined period of time. Each customer profile typically includes a maximum acceptable debit-to-income ratio DTI_{max,k} of a hypothetical shopping customer k and a maximum acceptable monthly payment Cₖ(DTI_{max,k}) reflecting the maximum acceptable monthly payment of the hypothetical customer k.

Typically, the method further includes storing a plurality of competing purchase loan product profiles reflecting a plurality of hypothetical competing purchase loan products expected to be available during the predetermined period of time. Each competing purchase loan product profile typically includes a rate Rₚ reflecting a loan rate of a competing purchase loan product p.

In addition, the method typically includes storing a plurality of rules for determining how each hypothetical shopping customer makes a purchase loan decision. The rules typically include rules for determining if each hypothetical shopping customer decides to purchase a purchase loan product and rules for determining which purchase loan product each hypothetical shopping customer decides to purchase from the first purchase loan product and the hypothetical competing purchase loan products.

Next, the demand volume of shopping customers for the first purchase loan product during the predetermined period of time is predicted by simulating the purchase loan decision of each hypothetical shopping customer. In addition, the demand volume of non-shopping customers for the first purchase loan product during the predetermined period of time is predicted.

Finally, the method includes predicting the demand volume Vₗₒₐₙ₁ of the first purchase loan product being offered at an interest rate of Rₗₒₐₙ₁. The demand volume of the first purchase loan product is typically equal to the sum of the predicted demand volume for the first purchase loan product from non-shopping customers during the predetermined period of time and the predicted demand volume of shopping customers for the first purchase loan product during the predetermined period of time.

In one embodiment, predicting the demand volume Vₗₒₐₙ₁ of the first purchase loan product includes calculating the demand volume Vₗₒₐₙ₁ using a demand volume model, the demand volume model defining:

$${V}_{loan 1} = {n}_{loan 1} + {γΣ}_{k} \frac{{W}_{loan 1 , k} \times ( {C}_{k} ( {DTI}_{max , k} ) - {C}_{k} ( {R}_{loan 1} ) )}{{W}_{loan 1 , k} \times ( \begin{matrix}{C}_{k} ( {DTI}_{max , k} ) - \\ {C}_{k} ( {R}_{loan 1} )\end{matrix} ) + {Σ}_{l} {W}_{p , k} \times ( {C}_{k} ( {DTI}_{max , k} ) - {C}_{k} ( {R}_{p} ) )}$$

wherein nₗₒₐₙ₁ is the predicted demand volume for the first purchase loan product from non-shopping customers during the predetermined period of time, γ is the ratio of the total number of expected shopping customers over the total number of hypothetical shopping customers, Rₗₒₐₙ₁ is the loan rate of the first purchase loan product, Cₖ(Rₗₒₐₙ₁) is the expected monthly loan payment of the first purchase loan product for the hypothetical customer k, and Cₖ(Rₚ) is the expected monthly loan payment of the competing purchase loan product p for the hypothetical customer k. The weighting function W_{loan1,k} is typically defined as:

$${W}_{loan 1 , k} = {w}_{loan 1} \times \frac{d {R}_{loan 1}}{d {P}_{loan 1}} \times {\partial }_{loan 1 , k} ;$$

wherein Wₗₒₐₙ₁ is the non-price value of the first financial institution,

$$\frac{d {R}_{loan 1}}{d {P}_{loan 1}}$$

is the rate at which points paid can buy down the rate Rₗₒₐₙ₁ of the first purchase loan product, and ∂_{loan1,k} is a conditional function defined as:

∂_{loan1,k}=0 if Cₖ(DTI_{max,k})<Cₖ(Rₗₒₐₙ₁)

∂_{loan1,k}=0 if customer k is ineligible for the first purchase loan product

∂_{loan1,k}=1 otherwise.

The weighting function W_{t,k} is typically defined as:

$${W}_{p , k} = {w}_{p} \times \frac{d {R}_{p}}{d {P}_{p}} \times {\partial }_{p , k} ;$$

wherein wₚ is the non-price value of the financial institution offering the competing purchase loan product p,

$$\frac{d {R}_{p}}{d {P}_{p}}$$

is the rate at which points paid can buy down the rate Rₚ of the competing purchase loan product p, and ∂_{p,k} is a conditional function defined as:

∂_{p,k}=0 if Cₖ(DTI_{max,k})<Cₖ(Rₗₒₐₙ₁)

∂_{p,k}=0 if customer k is ineligible for a competing purchase loan product p

∂_{p,k}=1 otherwise.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 depicts a method for predicting the demand for a loan refinancing product in accordance with an aspect of the present invention;

FIG. 2 depicts an exemplary system for predicting the demand for a loan refinancing product in accordance with an aspect of the present invention;

FIG. 3A depicts historical data representing funded refinance applications during the 4^{th} quarter of 2010 by a particular financial institution, which indicate that almost all customers who chose to purchase a loan refinancing product saved at least $50 on their monthly payment;

FIG. 3B depicts historical data representing funded refinance applications during the 4^{th} quarter of 2010 by a particular financial institution, which indicate that almost all customers who chose to purchase a loan refinancing product saved at least 5% on their monthly payment;

FIG. 4 depicts a method for predicting the demand for a purchase loan product in accordance with an aspect of the present invention; and

FIG. 5 depicts an exemplary system for predicting the demand for a purchase loan product in accordance with an aspect of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” and “financial entity” include any organization that processes financial transactions including, but not limited to, banks, credit unions, savings and loan associations, investment companies, stock brokerages, asses management firms, insurance companies and the like. In specific embodiments of the invention, use of the term “bank” is limited to a financial entity in which account-bearing customers conduct financial transactions, such as account deposits, withdrawals, transfers and the like.

In one aspect, the present invention embraces a customer centric system and method for pricing loan refinancing products. More particularly, this aspect of the present invention typically relates to a system and method for predicting the demand of one or more loan refinancing products offered by a financial institution. By predicting the demand for a plurality of hypothetical loan refinancing products being offered at different prices (e.g., at different interest rates), a financial institution can determine at which price to offer a loan refinancing product.

In order to predict the demand for a first loan refinancing product, the system and method in accordance with the present invention typically simulate the decision making process for each of a plurality of hypothetical customers. More particularly, the likelihood of each hypothetical customer choosing between the first loan refinancing product and one or more competing loan refinancing products is typically simulated. The likelihood of a hypothetical customer choosing a particular loan refinancing product is based upon principles as described herein.

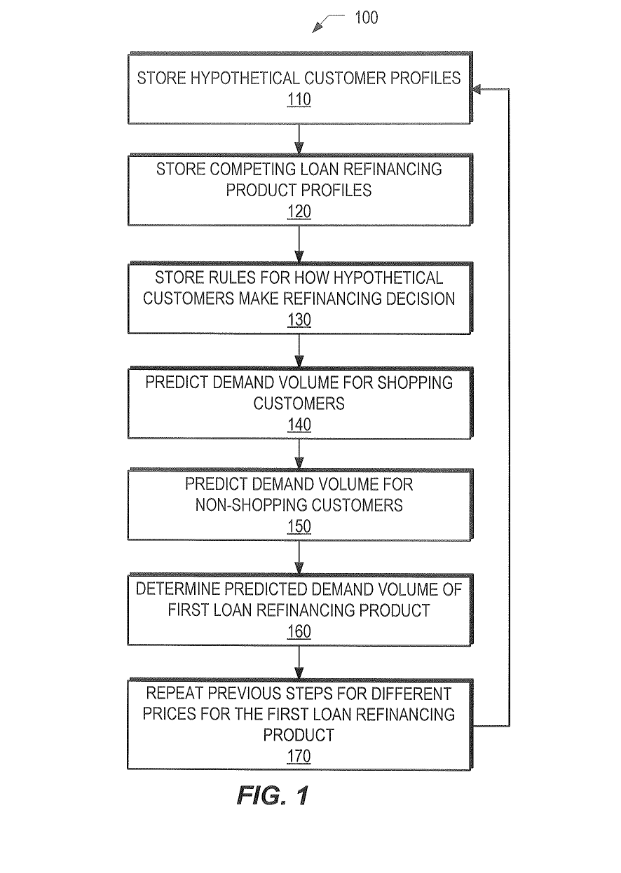

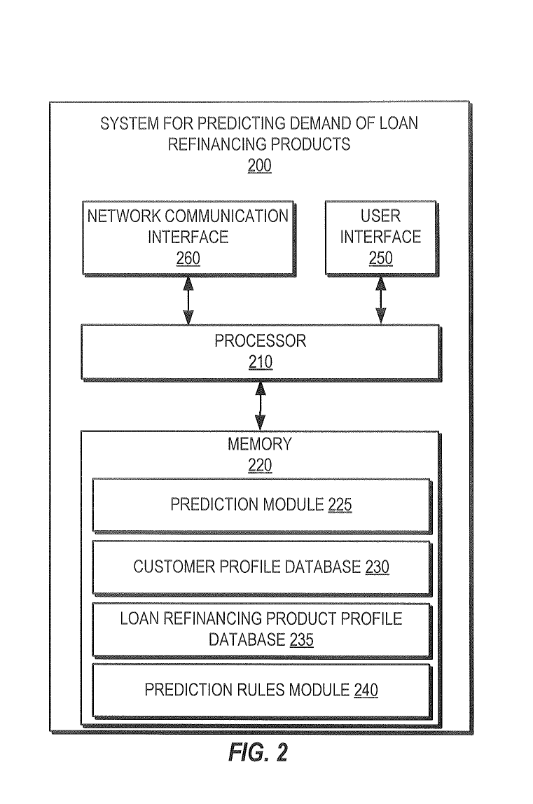

A method 100 for predicting the demand for a first loan refinancing product (e.g., for mortgage refinancing) offered by a first financial institution in accordance with one aspect of the present invention is depicted in FIG. 1. An exemplary system 200 for predicting the demand for the first loan refinancing product is depicted in FIG. 2. As depicted in FIG. 2, the system 200 typically includes a processor 210 and a memory 220. A prediction module 225 is typically stored in the memory 220 and is executable by the processor 210 to perform one or more of the steps of the method 100. The system 200 may also include a user interface 250 and network communication interface 260 for communicating with other devices and systems.

In step 110, a plurality of customer profiles reflecting a plurality of hypothetical shopping customers are stored (e.g., in a customer profile database 230). The hypothetical customers reflect the makeup of customers expected to be shopping for loan refinancing products during a predetermined period of time (e.g., a week, a month, or a year). In other words, the hypothetical customers when aggregated should reflect the makeup of expected shopping customers (e.g., in terms of financial makeup). Accordingly, the makeup of the hypothetical customers may be based upon various factors including the expected size of the market for loan refinancing products (e.g., based upon historical market size data from the past week or month) and the expected financial makeup (e.g., current loan rate, current loan monthly payment, credit score, and current loan-to-value ratio) of the customers. In one embodiment, the total number of hypothetical customers is equal to the expected total number of shopping customers, where the expected total number of shopping customers may be based upon various factors including the expected size of the market for loan refinancing products (e.g., based upon historical market size data from the past week or month). In an alternative embodiment, the hypothetical customers are a representative sample of the expected total number of shopping customers.

Each customer profile typically includes a rate Rₖ reflecting a current loan rate of a hypothetical shopping customer k and a monthly payment C(Rₖ) reflecting a current monthly loan payment of the hypothetical customer k. Other information, such as each hypothetical customer's remaining loan balance, credit score, and current loan-to-value ratio may also be included in the customer profiles.

As used herein, a “shopping customer” is a customer shopping for loan refinancing products at a plurality of financial institutions. In shopping between loan refinancing products, shopping customers are expected to select a loan refinancing product based upon price, more typically the monthly savings between the loan refinancing product and the customer's current monthly loan payment, and a non-price value (e.g., convenience, brand value, footprint, marketing activity, sales forces ability, and/or time to closing) of the financial institution offering the loan refinancing product. In contrast, a “non-shopping customer” is a customer that does not shop for loan refinancing products at a plurality of financial institutions. Instead, a “non-shopping customer” will only choose (or not choose) a loan refinancing product from a financial institution that the non-shopping customer has a strong relationship with (e.g., the financial institution that is the customer's current mortgage servicer) and without comparing loan refinancing products offered by other financial institutions.

In step 120, a plurality of competing loan refinancing product profiles reflecting a plurality of hypothetical competing loan refinancing products are stored (e.g., in a loan refinancing product profile database 235). The hypothetical competing loan refinancing products reflect the makeup of competing loan refinancing products expected to be available (e.g., available to the hypothetical customers) during the predetermined period of time. In other words, the hypothetical competing loan refinancing products when aggregated should reflect the makeup of expected competing loan refinancing products (e.g., in terms of loan rate). Accordingly, the makeup of the hypothetical competing loan refinancing products may be based upon recent (e.g., from the past week or month) competitor price data. Each competing loan refinancing product profile includes a rate Rₗ reflecting a loan rate of a competing loan refinancing product l.

In step 130, a plurality of rules for determining how each hypothetical shopping customer makes a loan refinancing decision are stored (e.g., in a prediction rules module 240). These rules typically include (i) rules for determining whether each hypothetical shopping customer will decide to purchase a loan refinancing product and (ii) rules for determining which loan refinancing product each hypothetical shopping customer will decide to purchase (e.g., choosing from the first loan refinancing product and the hypothetical competing loan refinancing products).

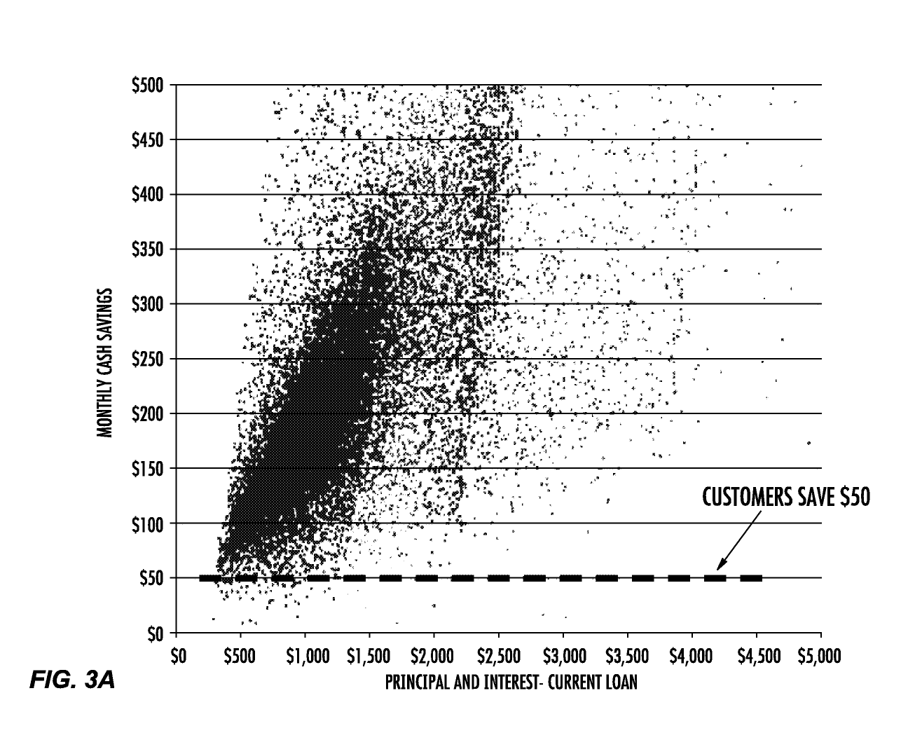

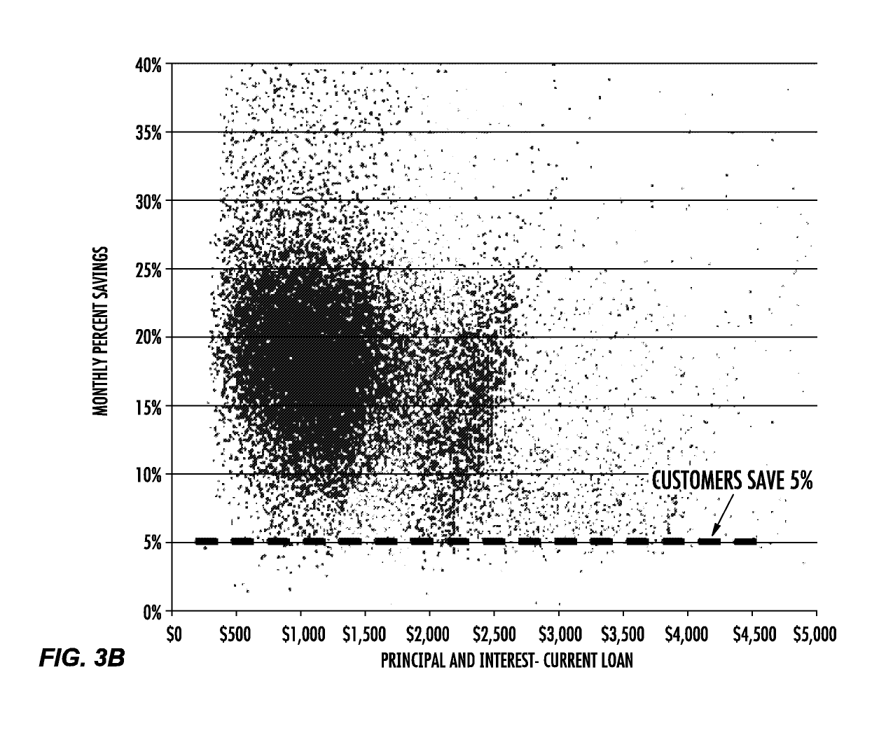

In determining whether a hypothetical customer k will decide to purchase a loan refinancing product, the customer's current monthly payment C(Rₖ) is compared against the expected monthly loan payment for each loan refinancing product (e.g., for the first loan refinancing product and for the competing loan refinancing products). In this regard, a hypothetical customer k will typically only decide to purchase a loan refinancing product if the expected monthly payment of the loan refinancing product is less than the current monthly loan payment C(Rₖ) of the hypothetical customer k. More typically, a hypothetical customer k will typically only decide to purchase a loan refinancing product if the expected monthly payment of the loan refinancing product is at least a predefined amount and/or a predefined percentage less than the current monthly loan payment C(Rₖ) of the hypothetical customer k. In a specific embodiment, the expected monthly payment must be at least 5% less than and at least $50 less than the current monthly loan payment C(Rₖ) of the hypothetical customer k. It has found that customers who choose to purchase a loan refinancing product typically save at least $50 and at least 5% on their monthly payment. In this regard, FIG. 3A depicts historical data representing funded refinance applications during the 4^{th} quarter of 2010 by a particular financial institution, which indicate that almost all customers who chose to purchase a loan refinancing product saved at least $50 on their monthly payment. Furthermore, FIG. 3B depicts historical data representing funded refinance applications during the 4^{th} quarter of 2010 by a particular financial institution, which indicate that almost all customers who chose to purchase a loan refinancing product saved at least 5% on their monthly payment.

In determining which loan refinancing product a hypothetical customer k will decide to purchase, the hypothetical customer k evaluates the monthly savings offered by each loan refinancing product as well as the non-price value of the financial institution offering each loan refinancing product. In one embodiment, the monthly savings of each loan refinancing product is multiplied by the non-price value of the financial institution offering the loan to determine a savings value for each loan refinancing product. The probably of the hypothetical customer k selecting any one of the loan refinancing products is then equal to the savings value of the loan refinancing product divided by the sum of the savings values of all of the loan refinancing products. Table 1 (below) illustrates the probably of a hypothetical customer selecting between an exemplary loan refinancing product being offered by a first financial institution and four competing loan refinancing products.

TABLE 1

| | | | Competing | Competing | Competing | Competing |
|---|---|---|---|---|---|---|
| | | Loan Offered | Loan Offered | Loan Offered | Loan Offered | Loan Offered |
| | Customer's | by First | by Second | by Third | by Fourth | by Fifth |
| | Current | Financial | Financial | Financial | Financial | Financial |
| | Loan | Institution | Institution | Institution | Institution | Institution |
| Rate | 5.25% | 4.75% | 4.875% | 5.50% | 4.625% | 4.875% |
| Monthly | $1,104 | $1,043 | $1,058 | $1,136 | $1,028 | $1,058 |
| Payment | | | | | | |
| Savings | | $61 | $46 | $0 | $76 | $46 |
| Non-Price | | 1.0 | 1.30 | 0.85 | 0.70 | 0.05 |
| Value | | | | | | |
| Savings Value | | 61.1 | 59.8 | 0.0 | 53.3 | 2.3 |
| Customer | | 35% | 34% | 0% | 30% | 1% |
| Decision | | | | | | |
| Probability | | | | | | |

The non-price value for each financial institution relates to various factors, which may include convenience, brand value, footprint, marketing activity, sales forces ability, and/or time to closing. A non-price value may be assigned to each financial institution. Alternatively, the non-price value of each financial institution may be determined by analyzing historical volume data for loan refinancing products at each financial institution to determine a non-price value that best fits the historical volume data (e.g., using regression analysis). In one embodiment, the non-price value of each financial institution may vary by geographic region. For example, a financial institution may have a higher non-price value in one region and a lower non-price value in another region. Non-price values determined from analyzing historical volume data may be adjusted to reflect recent changes to the financial institutions (e.g., recent growth, marketing campaigns, and/or strategy changes) that may not be fully reflected in the historical volume data.

In step 140, the demand volume of the shopping customers for the first loan refinancing product during the predetermined period of time is predicted by simulating the decision of each hypothetical shopping customer as described above. The demand volume of the shopping customers for the first loan refinancing product is typically the sum of the probabilities of each hypothetical shopping customer selecting the first loan refinancing product. For example, if there are 100 hypothetical shopping customers, each with a 10% probability of selecting a first loan refinancing product, then the predicted demand volume of the first loan refinancing product will be 10.

Accordingly, the demand volume of the shopping customers for the first loan refinancing product being offered at an interest rate of Rᵢₙₛₜ₁ may be modeled as:

$$γ {\sum }_{k}^{ } \frac{{W}_{inst 1 , k} \times ( C ( {R}_{k} ) - {C}_{k} ( {R}_{inst 1} ) )}{{W}_{inst 1 , k} \times ( C ( {R}_{k} ) - {C}_{k} ( {R}_{inst 1} ) ) + {\sum }_{l}^{ } {W}_{l , k} \times ( C ( {R}_{k} ) - {C}_{k} ( {R}_{l} ) )}$$

wherein γ is the ratio of the total number of expected shopping customers over the total number of hypothetical shopping customers, Rᵢₙₛₜ₁ is the loan rate of the first loan refinancing product, Cₖ(Rᵢₙₛₜ₁) is the expected monthly loan payment of the first loan refinancing product for the customer k, and Cₖ(Rₗ) is the expected monthly loan payment of the competing loan refinancing product l for the customer k. This equation produces the sum of the decision probabilities for all of the hypothetical customers, which is then multiplied by the ratio γ of the total number of expected shopping customers over the total number of hypothetical shopping customers. For example, if the number of hypothetical customers is equal to the number of expected shopping customers, then γ=1. By way of further example, if the number of hypothetical customers is 100 and the number of expected shopping customers is 10,000, then γ=100.

The weighting function W_{inst1,k} is typically defined as:

$${W}_{inst 1 , k} = {w}_{inst 1} \times \frac{d {R}_{inst 1}}{d {P}_{inst 1}} \times {\partial }_{inst 1 , k}$$

wherein wᵢₙₛₜ₁ is the non-price value of the first financial institution,

$$\frac{d {R}_{inst 1}}{d {P}_{inst 1}}$$

is the rate at which points paid can buy down the rate Rᵢₙₛₜ₁ of the first loan refinancing product, and ∂_{inst1,k} is a conditional function defined as:

∂_{inst1,k}=0 if C(Rₖ)+αC(Rₖ)<Cₖ(Rᵢₙₛₜ₁) or C(Rₖ)+β<Cₖ (Rᵢₙₛₜ₁)

∂_{inst1,k}=0 if customer k is ineligible for the first loan refinancing product

∂_{inst1,k}=1 otherwise

wherein α is a predetermined minimum percentage difference and β is a predetermined minimum difference. The predetermined minimum percentage difference α and the a predetermined minimum difference β ensure that the expected monthly payment Cₖ(Rᵢₙₛₜ₁) of the first loan refinancing product is sufficiently less than (e.g., at least 5% and $50 less than) the hypothetical customer's current monthly payment C(Rₖ). The conditional function ∂_{inst1,k} also ensures that the hypothetical customer k is eligible for the first loan refinancing product.

The weighting function W_{t,k} is typically defined as:

$${W}_{l , k} = {w}_{l} \times \frac{d {R}_{l}}{d {P}_{l}} \times {\partial }_{l , k}$$

wherein wₗ is the non-price value of the financial institution offering the competing loan refinancing product l, dRₗ/dPₗ is the rate at which points paid can buy down the rate Rₗ of the competing loan refinancing product l, and ∂_{l,k} is a conditional function defined as:

∂_{l,k}=0 if C(Rₖ)+αC(Rₖ)<Cₖ(Rₗ) or C(Rₖ)+β<Cₖ(Rₗ)

∂_{l,k}=0 if customer k is ineligible for a competing loan refinancing product l

∂_{l,k}=1 otherwise

wherein α is the predetermined minimum percentage difference and β is the predetermined minimum difference. The predetermined minimum percentage difference α and the a predetermined minimum difference β ensure that the expected monthly payment Cₖ(Rₗ) of the competing loan refinancing product l is sufficiently less than (e.g., at least 5% and $50 less than) the hypothetical customer's current monthly payment C(Rₖ). The conditional function ∂_{l,k} also ensures that the hypothetical customer k is eligible for the competing loan refinancing product l and, thus, accounts for the possibility that different competing financial institutions may have different qualifying criteria.

In step 150, the demand volume of non-shopping customers for the first loan refinancing product during the predetermined period of time is predicted. As used herein, a “non-shopping customer” is a customer who will only choose (or not choose) a loan refinancing product from a financial institution that the non-shopping customer has a strong relationship with (e.g., the financial institution that is the customer's current mortgage servicer) and without comparing loan refinancing products offered by other financial institutions. It has been found that a significant percentage (e.g., about 60%) of loan refinancing products sales come from non-shopping customers.

In order to predict the demand volume of non-shopping customers, historical volume data for loan refinancing products is typically analyzed to determine a historical ratio of the demand volume from non-shopping customers to the demand volume from shopping customers. For example, the above described model for determining the demand volume of the shopping customers for the first loan refinancing product may be applied to historical volume data (e.g., from the previous month or year) for loan refinancing products from the first financial institution to determine a historical ratio of the demand volume from non-shopping customers to the demand volume from shopping customers at the first financial institution (e.g., a ratio that best fits the historical volume data). Alternatively, the above described model for determining the demand volume of the shopping customers may be applied to historical market volume data (e.g., from the previous month or year) for loan refinancing products to determine a historical ratio of the demand volume from non-shopping customers to the demand volume from shopping customers in the entire market for loan refinancing products (e.g., a ratio that best fits the historical volume data). Once a historical ratio of the demand volume from non-shopping customers to the demand volume from shopping customers has been determined, this ratio may be multiplied by the predicted volume of shopping customers to thereby predict the volume of non-shopping customers. Alternatively, the historical ratio of the demand volume from non-shopping customers to the total demand volume (e.g., derived from the historical ratio of the demand volume from non-shopping customers to the demand volume from shopping customers) may be multiplied (i) by the expected total size of the market for loan refinancing products (e.g., derived from recent market size data from the past week, month, or year) and (ii) by the first financial institution's expected market share or expected percentage of the total market for loan refinancing products (e.g., derived from recent market size and market share data from the past week, month, or year) to thereby predict the volume of non-shopping customers.

In one embodiment, historical volume data for loan refinancing products may be analyzed to determine a relationship between the interest rate and the demand volume from non-shopping customers. The interest rate Rᵢₙₛₜ₁ of the first loan refinancing product may then be inserted into this relationship to thereby predict the volume of non-shopping customers for the first loan refinancing product. Varying the number of non-shopping customers as a function of interest rate may provide for a more accurate prediction when the interest rate of the first loan refinancing product significantly departs from recent interest rates than applying the demand volume model to historical data as described above.

It is expected that the demand from non-shopping customers for products offered by a particular financial institution may vary by geographic region. For example, the footprint of a financial institution may vary by region. Accordingly, in one embodiment, the volume of non-shopping customers for the first loan refinancing product may be separately predicted for each geographic region.

In step 160, the predicted demand volume Vᵢₙₛₜ₁ of the first loan refinancing product is determined. The predicted demand volume Vᵢₙₛₜ₁ of the first loan refinancing product is equal to the sum of (i) the demand volume from shopping customers and (ii) the demand volume from non-shopping customers. Accordingly, the demand volume Vᵢₙₛₜ₁ of the first loan refinancing product may be modeled as:

$${V}_{inst 1} = {n}_{inst 1} + γ {\sum }_{k}^{ } \frac{{W}_{inst 1 , k} \times ( C ( {R}_{k} ) - {C}_{k} ( {R}_{inst 1} ) )}{{W}_{inst 1 , k} \times ( C ( {R}_{k} ) - {C}_{k} ( {R}_{inst 1} ) ) + {\sum }_{l}^{ } {W}_{l , k} \times ( C ( {R}_{k} ) - {C}_{k} ( {R}_{l} ) )}$$

wherein nᵢₙₛₜ₁ is the demand volume from non-shopping customers.

As described above, this demand volume model for a loan refinancing product may be applied to historical volume data for loan refinancing products to determine values for the fit parameters, namely the demand volume nᵢₙₛₜ₁ from non-shopping customers and the non-price value (i.e., wᵢₙₛₜ₁ and wₗ) of the various financial institutions offering loan refinancing products that best fit the historical volume data (e.g., using regression analysis). Once determined, these fit parameters can be employed in the model to predict the demand for the first loan refinancing product offered by the first financial institution during the predetermined period of time. Similarly, the demand volume model can be employed to predict the demand volume for each of the competing loan refinancing products.

In one embodiment, the first financial institution may offer more than one loan refinancing product. In such a circumstance, the foregoing demand volume model may be currently simulated for each loan refinancing product offered by the first financial institution, where the other loan refinancing product offered by the first financial institution is treated as a competing loan refinancing product. For example, if the first financial institution offers a first loan refinancing product and a second loan refinancing product, the demand volume model is run (i) for the first loan refinancing product where the second loan refinancing product is treated as a competing product and (ii) for second loan refinancing product wherein the first loan refinancing product is treated as a competing product.

In step 170, the previous steps (i.e., steps 110-160) may be repeated for a plurality of different prices, typically different interest rates, for the first loan refinancing product to predict the demand volume of the first loan refinancing product at each of the different prices. The combination of price and predicted volume of the first loan refinancing product may then be employed by the first financial institution to determine the price at which to offer the first loan refinancing product in the market.

The demand volume model for loan refinancing products in accordance with the present invention has been found to be significantly more accurate than previous product-level elasticity models in predicting the demand for a loan refinancing product. In this regard, the present demand volume model was tested by running the model over the 2010 calendar year for sales of conforming fixed loan refinance products at a particular financial institution. The above described fit parameters (e.g., volume of non-shopping customers and the non-price value of the different competing financial institutions) were determined using a deterministic round-robin downhill method on the previous 30 days of data. The results of this model were compared against the actual sales volume during the 2010 calendar year. The present demand volume model was found to have an average error (i.e., different from the actual sales volume) of 8.1%.

A product-level elasticity model was also run over the 2010 calendar year for sales of conforming fixed loan refinance products at the particular financial institution. In comparison with the actual sales volume during the 2010 calendar year, the product-level elasticity model was found to have an average error of 16.1%. Accordingly, the present demand volume model has a significant reduction in error as compared with product-level elasticity models.

In another aspect, the present invention embraces a customer centric system and method for pricing purchase loan products (e.g., mortgages). More particularly, this aspect of the present invention typically relates to a system and method for predicting the demand of one or more purchase loan products offered by a financial institution. By predicting the demand for a plurality of hypothetical purchase loan products being offered at different prices (e.g., at different interest rates), a financial institution can determine at which price to offer a purchase loan product.

In order to predict the demand for a first purchase loan product, the system and method in accordance with the present invention typically simulate the decision making process for each of a plurality of hypothetical customers. More particularly, the likelihood of each hypothetical customer choosing between the first purchase loan product and one or more competing purchase loan products is typically simulated. The likelihood of a hypothetical customer choosing a particular purchase loan product is based upon principles as described herein.

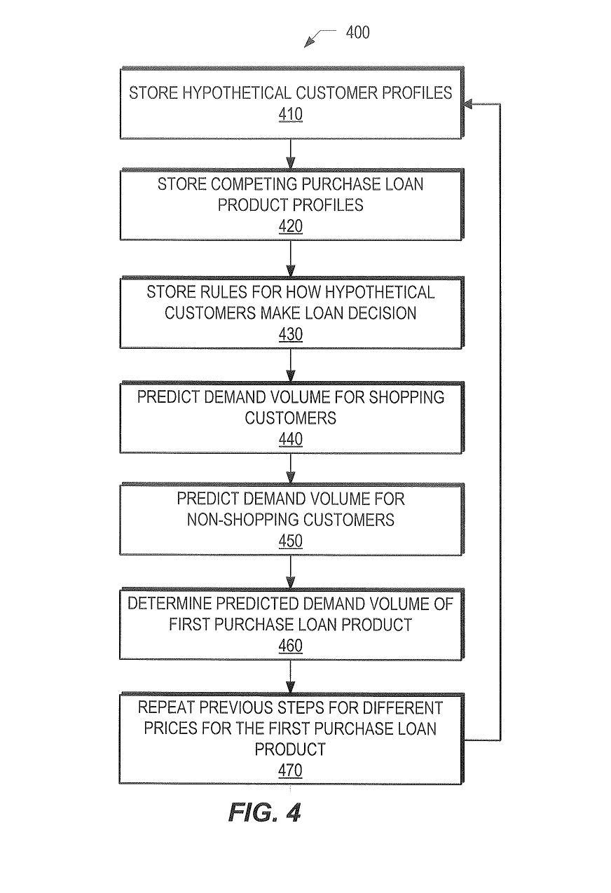

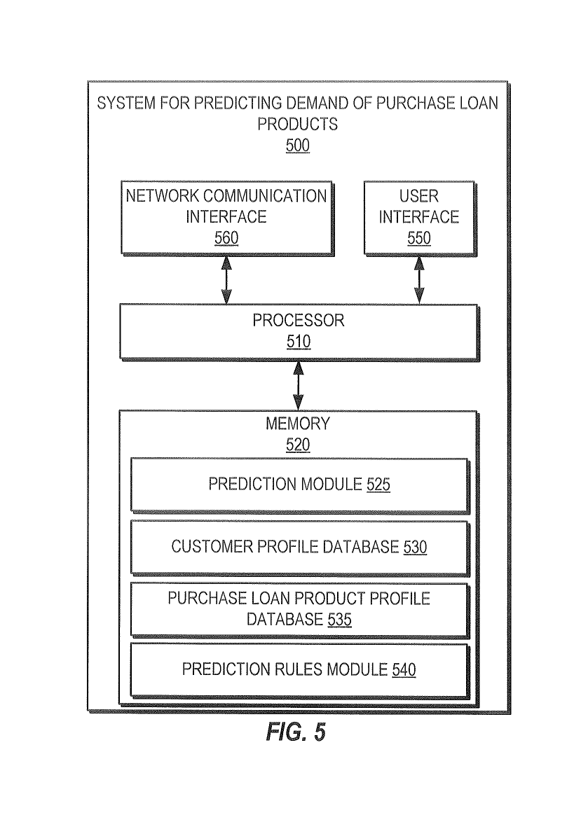

A method 400 for predicting the demand for a first purchase loan product offered by a first financial institution in accordance with one aspect of the present invention is depicted in FIG. 4. An exemplary system 500 for predicting the demand for the first purchase loan product is depicted in FIG. 5. As depicted in FIG. 5, the system 500 typically includes a processor 510 and a memory 520. A prediction module 525 is typically stored in the memory 520 and is executable by the processor 510 to perform one or more of the steps of the method 400. The system 500 may also include a user interface 550 and a network communication interface 560 for communicating with other devices and systems.

In step 410, a plurality of customer profiles reflecting a plurality of hypothetical shopping customers are stored (e.g., in a customer profile database 530). The hypothetical customers reflect the makeup of customers expected to be shopping for purchase loan products during a predetermined period of time (e.g., a week, a month, or a year). In other words, the hypothetical customers when aggregated should reflect the makeup of expected shopping customers (e.g., in terms of financial makeup). Accordingly, the makeup of the hypothetical customers may be based upon various factors including the expected size of the market for purchase loan products (e.g., based upon historical market size data from the past week or month) and the expected financial makeup (e.g., expected loan amount, current income, credit score, current loan-to-value ratio, and maximum acceptable debit-to-income ratio) of the customers. In this regard, the distribution of maximum acceptable debt-to-income ratios of the hypothetical customers should reflect the distribution of the debt-to-income ratios of customers who purchased purchase loan products as found in recent historical data (e.g., from the previous month). In one embodiment, the distribution of maximum acceptable debt-to-income ratios for the hypothetical customers may vary by geographic region. For example, hypothetical customers may, on average, have higher maximum acceptable debt-to-income ratios in geographic regions having a high cost of living than hypothetical customers in geographic regions having a lower cost of living. In one embodiment, the total number of hypothetical customers is equal to the expected total number of shopping customers, where the expected total number of shopping customers may be based upon various factors including the expected size of the market for purchase loan products (e.g., based upon historical market size data from the past week or month). In an alternative embodiment, the hypothetical customers are a representative sample of the expected total number of shopping customers.

Each customer profile typically includes a maximum acceptable debit-to-income ratio DTI_{max,k} (e.g., based upon customer preference) and a maximum acceptable monthly payment Cₖ(DTI_{max,k}), which reflects the maximum acceptable monthly payment for the hypothetical customer k based upon the hypothetical customer's maximum acceptable debit-to-income ratio DTI_{max,k}. The maximum acceptable debt-to-income ratios of the hypothetical customer's will typically vary (e.g., each hypothetical customer may have a unique maximum acceptable debt-to-income ratio). Because a customer's maximum acceptable debt-to-income ratio is typically based upon the customer's preference and not loan requirements, a hypothetical's customer's maximum acceptable debt-to-income ratio may be more or less than a maximum debt-to-income ratio allowed by a financial institution offering a purchase loan product. Other information, such as each hypothetical customer's expected loan amount, income, credit score, and loan-to-value ratio may also be included in the customer profiles.

As used herein, a “shopping customer” is a customer shopping for purchase loan products at a plurality of financial institutions. In shopping between purchase loan products, shopping customers are expected to select a purchase loan product based upon price, more typically the difference between the expected monthly payment for the purchase loan product and the customer's maximum acceptable monthly payment, and a non-price value (e.g., convenience, brand value, footprint, marketing activity, sales forces ability, and/or time to closing) of the financial institution offering the purchase loan product. In contrast, a “non-shopping customer” is a customer that does not shop for purchase loan products at a plurality of financial institutions. Instead, a “non-shopping customer” will only choose (or not choose) a purchase loan product from a financial institution without comparing purchase loan products offered by other financial institutions.

In step 420, a plurality of competing purchase loan product profiles reflecting a plurality of hypothetical competing purchase loan products are stored (e.g., in a purchase loan product profile database 535). The hypothetical competing purchase loan products reflect the makeup of competing purchase loan products expected to be available (e.g., available to the hypothetical customers) during the predetermined period of time. In other words, the hypothetical competing purchase loan products when aggregated should reflect the makeup of expected competing purchase loan products (e.g., in terms of loan rate). Accordingly, the makeup of the hypothetical competing purchase loan products may be based upon recent (e.g., from the past week or month) competitor price data. Each competing purchase loan product profile includes a rate Rₚ reflecting a loan rate of a competing purchase loan product p.

In step 430, a plurality of rules for determining how each hypothetical shopping customer makes a purchase loan decision are stored (e.g., in a prediction rules module 540). These rules typically include (i) rules for determining whether each hypothetical shopping customer will decide to purchase a purchase loan product and (ii) rules for determining which purchase loan product each hypothetical shopping customer will decide to purchase (e.g., choosing from the first purchase loan product and the hypothetical competing purchase loan products).

In determining whether a hypothetical customer k will decide to purchase a purchase loan product, the customer's maximum acceptable monthly payment Cₖ(DTI_{max,k}) is compared against the expected monthly loan payment for each purchase loan product (e.g., for the first purchase loan product and for the competing purchase loan products). In this regard, a hypothetical customer k will typically only decide to purchase a purchase loan product if the expected monthly payment of the purchase loan product is less than the customer's maximum acceptable monthly payment Cₖ(DTI_{max,k}).

In determining which purchase loan product a hypothetical customer k will decide to purchase, the hypothetical customer k evaluates the monthly payment of each purchase loan product as well as the non-price value of the financial institution offering each purchase loan product. In one embodiment, the difference between the customer's maximum acceptable monthly payment Cₖ(DTIₘₐₓ) and the monthly payment of each purchase loan product is multiplied by the non-price value of the financial institution offering the loan to determine a DTI differential value for each purchase loan product. The DTI differential value, however, is 0 if the expected monthly payment of the purchase loan product is greater than the customer's maximum acceptable monthly payment Cₖ(DTIₘₐₓ). The probably of the hypothetical customer k selecting any one of the purchase loan products is then equal to the DTI differential value of the purchase loan product divided by the sum of the DTI differential values of all of the purchase loan products. Table 2 (below) illustrates the probably of a hypothetical customer selecting between an exemplary purchase loan product being offered by a first financial institution and four competing purchase loan products.

TABLE 2

| | Customer's | | Competing | Competing | Competing | Competing |
|---|---|---|---|---|---|---|
| | Maximum | Loan Offered | Loan Offered | Loan Offered | Loan Offered | Loan Offered |
| | Acceptable | by First | by Second | by Third | by Fourth | by Fifth |
| | Monthly | Financial | Financial | Financial | Financial | Financial |
| | Payment | Institution | Institution | Institution | Institution | Institution |
| Rate | | 4.75% | 4.875% | 5.50% | 4.625% | 4.875% |
| Monthly | $1,104 | $1,043 | $1,058 | $1,136 | $1,028 | $1,058 |
| Payment | | | | | | |
| Difference | | $61 | $46 | −$32 | $76 | $46 |
| Non-Price | | 1.0 | 1.30 | 0.85 | 0.70 | 0.05 |
| Value | | | | | | |
| DTI | | 61.1 | 59.8 | 0.0 | 53.3 | 2.3 |
| Differential | | | | | | |
| Value | | | | | | |
| Customer | | 35% | 34% | 0% | 30% | 1% |
| Decision | | | | | | |
| Probability | | | | | | |

The non-price value for each financial institution relates to various factors, which may include convenience, brand value, footprint, marketing activity, sales forces ability, and/or time to closing. A non-price value may be assigned to each financial institution. Alternatively, the non-price value of each financial institution may be determined by analyzing historical volume data for purchase loan products at each financial institution to determine a non-price value that best fits the historical volume data (e.g., using regression analysis). In one embodiment, the non-price value of each financial institution may vary by geographic region. For example, a financial institution may have a higher non-price value in one region and a lower non-price value in another region. Non-price values determined from analyzing historical volume data may be adjusted to reflect recent changes to the financial institutions (e.g., recent growth, marketing campaigns, and/or strategy changes) that may not be fully reflected in the historical volume data.

In step 440, the demand volume of the shopping customers for the first purchase loan product during the predetermined period of time is predicted by simulating the decision of each hypothetical shopping customer as described above. The demand volume of the shopping customers for the first purchase loan product is typically the sum of the probabilities of each hypothetical shopping customer selecting the first purchase loan product. For example, if there are 100 hypothetical shopping customers, each with a 10% probability of selecting a first purchase loan product, then the predicted demand volume of the first purchase loan product will be 10.

Accordingly, the demand volume of the shopping customers for the first purchase loan product being offered at an interest rate of Rₗₒₐₙ₁ may be modeled as:

$$γ {\sum }_{k}^{ } \frac{{W}_{loan 1 , k} \times ( {C}_{k} ( {DTI}_{max , k} ) - {C}_{k} ( {R}_{loan 1} ) )}{\begin{matrix}{W}_{loan 1 , k} \times ( {C}_{k} ( {DTI}_{max , k} ) - {C}_{k} ( {R}_{loan 1} ) ) + \\ {\sum }_{l}^{ } {W}_{p , k} \times ( {C}_{k} ( {DTI}_{max , k} ) - {C}_{k} ( {R}_{p} ) )\end{matrix}}$$

wherein γ is the ratio of the total number of expected shopping customers over the total number of hypothetical shopping customers, Rₗₒₐₙ₁ is the loan rate of the first purchase loan product, Cₖ(Rₗₒₐₙ₁) is the expected monthly loan payment of the first purchase loan product for the customer k, and Cₖ(Rₚ) is the expected monthly loan payment of the competing purchase loan product p for the customer k. This equation produces the sum of the decision probabilities for all of the hypothetical customers, which is then multiplied by the ratio γ of the total number of expected shopping customers over the total number of hypothetical shopping customers. For example, if the number of hypothetical customers is equal to the number of expected shopping customers, then γ=1. By way of further example, if the number of hypothetical customers is 100 and the number of expected shopping customers is 10,000, then γ=100.

The weighting function W_{loan1,k} is typically defined as:

$${W}_{loan 1 , k} = {w}_{loan 1} \times \frac{d {R}_{loan 1}}{d {P}_{loan 1}} \times {\partial }_{loan 1 , k}$$

wherein wᵢₙₛₜ₁ is the non-price value of the first financial institution,

$$\frac{d {R}_{inst 1}}{d {P}_{inst 1}}$$

is the rate at which points paid can buy down the rate Rₗₒₐₙ₁ of the first purchase loan product, and ∂_{loan1,k} is a conditional function defined as:

∂_{loan1,k}=0 if Cₖ(DTI_{max,k})<Cₖ(Rₗₒₐₙ₁)

∂_{loan1,k}=0 if customer k is ineligible for the first purchase loan product

∂_{loan1,k}=1 otherwise

The conditional function ∂_{loan1,k} ensures that the expected monthly payment of the purchase loan product is not greater than the customer's maximum acceptable monthly payment Cₖ(DTI_{max,k}). The conditional function also ensures that the hypothetical customer k is eligible for the first purchase loan product. For example, a financial may require that a hypothetical customer have a debt-to-income ratio that is below a particular threshold.

The weighting function W_{p,k} is typically defined as:

$${W}_{p , k} = {w}_{p} \times \frac{d {R}_{p}}{d {P}_{p}} \times {\partial }_{p , k}$$

wherein wₚ is the non-price value of the financial institution offering the competing purchase loan product p,

$$\frac{d {R}_{p}}{d {P}_{p}}$$

is the rate at which points paid can buy down the rate Rₚ of the competing purchase loan product p, and ∂_{p,k} is a conditional function defined as:

∂_{p,k}=0 if Cₖ(DTIₘₐₓ)<Cₖ(Rₗₒₐₙ₁)

∂_{p,k}=0 if customer k is ineligible for a competing purchase loan product l

∂_{p,k}=1 otherwise

The conditional function ∂_{p,k} ensures that the expected monthly payment of the purchase loan product is not greater than the customer's maximum acceptable monthly payment Cₖ(DTI_{max,k}). The conditional function ∂_{p,k} also ensures that the hypothetical customer k is eligible for the competing purchase loan product p and, thus, accounts for the possibility that different competing financial institutions may have different qualifying criteria.

In step 450, the demand volume of non-shopping customers for the first purchase loan product during the predetermined period of time is predicted. As used herein, a “non-shopping customer” is a customer who will only choose (or not choose) a purchase loan product from a financial institution without comparing purchase loan products offered by other financial institutions. For example, many customers needing a mortgage for a home purchase choose a purchase loan product from a financial institution based upon the recommendations of their real estate agent without comparing products offered by other financial institutions. It is expected that a significant percentage of purchase loan products sales come from non-shopping customers.

In order to predict the demand volume of non-shopping customers, historical volume data for purchase loan products is typically analyzed to determine a historical ratio of the demand volume from non-shopping customers to the demand volume from shopping customers. For example, the above described model for determining the demand volume of the shopping customers for the first purchase loan product may be applied to historical volume data (e.g., from the previous month or year) for purchase loan products from the first financial institution to determine a historical ratio of the demand volume from non-shopping customers to the demand volume from shopping customers at the first financial institution (e.g., a ratio that best fits the historical volume data). Alternatively, the above described model for determining the demand volume of the shopping customers may be applied to historical market volume data (e.g., from the previous month or year) for purchase loan products to determine a historical ratio of the demand volume from non-shopping customers to the demand volume from shopping customers in the entire market for purchase loan products (e.g., a ratio that best fits the historical volume data). Once a historical ratio of the demand volume from non-shopping customers to the demand volume from shopping customers has been determined, this ratio may be multiplied by the predicted volume of shopping customers to thereby predict the volume of non-shopping customers. Alternatively, the historical ratio of the demand volume from non-shopping customers to the total demand volume (e.g., derived from the historical ratio of the demand volume from non-shopping customers to the demand volume from shopping customers) may be multiplied (i) by the expected total size of the market for purchase loan products (e.g., derived from recent market size data from the past week, month, or year) and (ii) by the first financial institution's expected market share or expected percentage of the total market for purchase loan products (e.g., derived from recent market size and market share data from the past week, month, or year) to thereby predict the volume of non-shopping customers.

In one embodiment, historical volume data for purchase loan products may be analyzed to determine a relationship between the interest rate and the demand volume from non-shopping customers. The interest rate Rₗₒₐₙ₁ of the first purchase loan product may then be inserted into this relationship to thereby predict the volume of non-shopping customers for the first purchase loan product. Varying the number of non-shopping customers as a function of interest rate may provide for a more accurate prediction when the interest rate of the first purchase loan product significantly departs from recent interest rates than applying the demand volume model to historical data as described above.

It is expected that the demand from non-shopping customers for products offered by a particular financial institution may vary by geographic region. For example, the footprint of a financial institution and the strength of its relationships with real estate agents may vary by region. Accordingly, in one embodiment, the volume of non-shopping customers for the first purchase loan product may be separately predicted for each geographic region.

In step 460, the predicted demand volume Vₗₒₐₙ₁ of the first purchase loan product is determined. The predicted demand volume Vₗₒₐₙ₁ of the first purchase loan product is equal to the sum of (i) the demand volume from shopping customers and (ii) the demand volume from non-shopping customers. Accordingly, the demand volume Vₗₒₐₙ₁ of the first purchase loan product may be modeled as:

$${V}_{loan 1} = {n}_{loan 1} + γ {\sum }_{k}^{ } \frac{{W}_{loan 1 , k} \times ( {C}_{k} ( {DTI}_{max , k} ) - {C}_{k} ( {R}_{loan 1} ) )}{\begin{matrix}{W}_{loan 1 , k} \times ( {C}_{k} ( {DTI}_{max , k} ) - {C}_{k} ( {R}_{loan 1} ) ) + \\ {\sum }_{l}^{ } {w}_{p , k} \times ( {C}_{k} ( {DTI}_{max , k} ) - {C}_{k} ( {R}_{p} ) )\end{matrix}}$$

wherein nₗₒₐₙ₁ is the demand volume from non-shopping customers.

As described above, this demand volume model for a purchase loan product may be applied to historical volume data for purchase loan products to determine values for the fit parameters, namely the demand volume nₗₒₐₙ₁ from non-shopping customers and the non-price value (i.e., wₗₒₐₙ₁ and wₚ) of the various financial institutions offering purchase loan products that best fit the historical volume data (e.g., using regression analysis). Once determined, these fit parameters can be employed in the model to predict the demand for the first purchase loan product offered by the first financial institution during the predetermined period of time. Similarly, the demand volume model can be employed to predict the demand volume for each of the competing purchase loan products.

In one embodiment, the first financial institution may offer more than one purchase loan product. In such a circumstance, the foregoing demand volume model may be currently simulated for each purchase loan product offered by the first financial institution, where the other purchase loan product offered by the first financial institution is treated as a competing purchase loan product. For example, if the first financial institution offers a first purchase loan product and a second purchase loan product, the demand volume model is run (i) for the first purchase loan product where the second purchase loan product is treated as a competing product and (ii) for second purchase loan product wherein the first purchase loan product is treated as a competing product.

In step 470, the previous steps (i.e., steps 410-460) may be repeated for a plurality of different prices, typically different interest rates, for the first purchase loan product to predict the demand volume of the first purchase loan product at each of the different prices. The combination of price and predicted volume of the first purchase loan product may then be employed by the first financial institution to determine the price at which to offer the first purchase loan product in the market.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for predicting the demand of a first purchase loan product provided by a first financial institution, comprising:
a computer apparatus including a processor and a memory;
a customer profile database stored in the memory, the customer profile database comprising a plurality of customer profiles reflecting a plurality of hypothetical shopping customers, the hypothetical customers reflecting the makeup of customers expected to be shopping for purchase loan products during a predetermined period of time, each customer profile including a maximum acceptable debit-to-income ratio DTI_{max,k} of a hypothetical shopping customer k and a maximum acceptable monthly payment Cₖ(DTI_{max,k}) reflecting the maximum acceptable monthly payment of the hypothetical customer k;
a purchase loan product profile database stored in the memory, the purchase loan product profile database comprising a plurality of competing purchase loan product profiles reflecting a plurality of hypothetical competing purchase loan products expected to be available during the predetermined period of time, each competing purchase loan product profile including a rate Rₚ reflecting a loan rate of a competing purchase loan product p;
a prediction rules module stored in the memory, the prediction rules module comprising rules for determining how each hypothetical shopping customer makes a purchase loan decision, the rules comprising rules for determining if each hypothetical shopping customer decides to purchase a purchase loan product and rules for determining which purchase loan product each hypothetical shopping customer decides to purchase from the first purchase loan product and the hypothetical competing purchase loan products;
a prediction module stored in the memory, executable by the processor and configured for:
predicting the demand volume of shopping customers for the first purchase loan product during the predetermined period of time by simulating the purchase loan decision of each hypothetical shopping customer;
predicting the demand volume of non-shopping customers for the first purchase loan product during the predetermined period of time; and
predicting the demand volume Vₗₒₐₙ₁ of the first purchase loan product being offered at an interest rate of Rₗₒₐₙ₁, wherein the demand volume of the first purchase loan product is equal to the sum of the predicted demand volume for the first purchase loan product from non-shopping customers during the predetermined period of time and the predicted demand volume of shopping customers for the first purchase loan product during the predetermined period of time.

2. The system according to claim 1, wherein the hypothetical competing purchase loan products comprise a second purchase loan product provided by the first financial institution.

3. The system according to claim 1, wherein predicting the demand volume of non-shopping customers for the first purchase loan product during the predetermined period of time is based upon analyzing historical volume data for purchase loan products to determine a historical ratio of a historical demand volume of non-shopping customers for purchase loan products to a historical total demand volume for purchase loan products.

4. The system according to claim 1, wherein predicting the demand volume Vₗₒₐₙ₁ of the first purchase loan product comprises calculating the demand volume Vₗₒₐₙ₁ using a demand volume model, the demand volume model defining:
$${V}_{loan 1} = {n}_{loan 1} + γ {\sum }_{k} \frac{{W}_{loan 1 , k} \times ( {C}_{k} ( {DTI}_{max , k} ) - {C}_{k} ( {R}_{loan 1} ) )}{\begin{matrix}{W}_{loan 1 , k} \times ( {C}_{k} ( {DTI}_{max , k} ) - {C}_{k} ( {R}_{loan 1} ) ) + \\ {\sum }_{l} {W}_{p , k} \times ( {C}_{k} ( {DTI}_{max , k} ) - {C}_{k} ( {R}_{p} ) )\end{matrix}} ;$$
nₗₒₐₙ₁ is the predicted demand volume for the first purchase loan product from non-shopping customers during the predetermined period of time;
γ is the ratio of the total number of expected shopping customers over the total number of hypothetical shopping customers;
Rₗₒₐₙ₁ is the loan rate of the first purchase loan product;
Cₖ(Rₗₒₐₙ₁) is the expected monthly loan payment of the first purchase loan product for the customer k;
Cₖ(Rₚ) is the expected monthly loan payment of the competing purchase loan product p for the customer k;
$${W}_{loan 1 , k} = {w}_{loan 1} \times \frac{d {R}_{loan 1}}{d {P}_{loan 1}} \times {\partial }_{loan 1 , k} ;$$
wₗₒₐₙ₁ is a non-price value of the first financial institution;
$$\frac{d {R}_{loan 1}}{d {P}_{loan 1}}$$
is the rate at which points paid can buy down the rate Rₗₒₐₙ₁ of the first purchase loan product;
∂_{loan1,k}=0 if Cₖ(DTI_{max,k})<Cₖ(Rₗₒₐₙ₁);
∂_{loan1,k}=0 if customer k is ineligible for the first purchase loan product;
∂_{loan1,k}=1 otherwise;
$${W}_{p , k} = {w}_{p} \times \frac{d {R}_{p}}{d {P}_{p}} \times {\partial }_{p , k} ;$$
wₚ is a non-price value of the financial institution offering the competing purchase loan product p;
$$\frac{d {R}_{p}}{d {P}_{p}}$$
is the rate at which points paid can buy down the rate Rₚ of the competing purchase loan product p;
∂_{p,k}=0 if Cₖ(DTIₘₐₓ)<Cₖ(Rₗₒₐₙ₁);
∂_{p,k}=0 if customer k is ineligible for a competing purchase loan product p;
∂_{p,k}=1 otherwise.

5. The system according to claim 4, wherein the prediction module is configured for:
assigning a value for the non-price value wₗₒₐₙ₁ of the first financial institution; and
determining the non-price value wₚ of each financial institution offering each competing purchase loan product by applying the demand volume model to historical volume data for purchase loan products at each financial institution offering each competing purchase loan product to determine a value for the non-price value wₚ of each financial institution offering each competing purchase loan product that best fits the historical volume data for purchase loan products at each financial institution offering each competing purchase loan product.

6. The system according to claim 4, wherein the prediction module is configured for predicting the demand volume of first purchase loan product at each of a plurality of different interest rates by calculating the demand volume of the first purchase loan product at each of the plurality of different interest rates using the demand volume model.

7. A computer program product for predicting the demand of a first purchase loan product provided by a first financial institution, comprising a non-transitory computer-readable storage medium having computer-executable instructions for:
storing a plurality of customer profiles reflecting a plurality of hypothetical shopping customers, the hypothetical customers reflecting the makeup of customers expected to be shopping for purchase loan products during a predetermined period of time, each customer profile including a maximum acceptable debit-to-income ratio DTI_{max,k} of a hypothetical shopping customer k and a maximum acceptable monthly payment Cₖ(DTI_{max,k}) reflecting the maximum acceptable monthly payment of the hypothetical customer k;
storing a plurality of competing purchase loan product profiles reflecting a plurality of hypothetical competing purchase loan products expected to be available during the predetermined period of time, each competing purchase loan product profile including a rate Rₚ reflecting a loan rate of a competing purchase loan product p;
storing a plurality of rules for determining how each hypothetical shopping customer makes a purchase loan decision, the rules comprising rules for determining if each hypothetical shopping customer decides to purchase a purchase loan product and rules for determining which purchase loan product each hypothetical shopping customer decides to purchase from the first purchase loan product and the hypothetical competing purchase loan products;
predicting the demand volume of shopping customers for the first purchase loan product during the predetermined period of time by simulating the purchase loan decision of each hypothetical shopping customer;
predicting the demand volume of non-shopping customers for the first purchase loan product during the predetermined period of time;
predicting the demand volume Vₗₒₐₙ₁ of the first purchase loan product being offered at an interest rate of Rₗₒₐₙ₁, wherein the demand volume of the first purchase loan product is equal to the sum of the predicted demand volume for the first purchase loan product from non-shopping customers during the predetermined period of time and the predicted demand volume of shopping customers for the first purchase loan product during the predetermined period of time.

8. The computer program product according to claim 7, wherein the hypothetical competing purchase loan products comprise a second purchase loan product provided by the first financial institution.

9. The computer program product according to claim 7, wherein predicting the demand volume of non-shopping customers for the first purchase loan product during the predetermined period of time is based upon analyzing historical volume data for purchase loan products to determine a historical ratio of a historical demand volume of non-shopping customers for purchase loan products to a historical total demand volume for purchase loan products.

10. The computer program product according to claim 7, wherein predicting the demand volume Vₗₒₐₙ₁ of the first purchase loan product comprises calculating the demand volume Vₗₒₐₙ₁ using a demand volume model, the demand volume model defining:
$${V}_{loan 1} = {n}_{loan 1} + γ {\sum }_{k} \frac{{W}_{loan 1 , k} \times ( {C}_{k} ( {DTI}_{max , k} ) - {C}_{k} ( {R}_{loan 1} ) )}{\begin{matrix}{W}_{loan 1 , k} \times ( {C}_{k} ( {DTI}_{max , k} ) - {C}_{k} ( {R}_{loan 1} ) ) + \\ {\sum }_{l} {W}_{p , k} \times ( {C}_{k} ( {DTI}_{max , k} ) - {C}_{k} ( {R}_{p} ) )\end{matrix}} ;$$
nₗₒₐₙ₁ is the predicted demand volume for the first purchase loan product from non-shopping customers during the predetermined period of time;
γ is the ratio of the total number of expected shopping customers over the total number of hypothetical shopping customers;
Rₗₒₐₙ₁ is the loan rate of the first purchase loan product;
Cₖ(Rₗₒₐₙ₁) is the expected monthly loan payment of the first purchase loan product for the customer k;
Cₖ(Rₚ) is the expected monthly loan payment of the competing purchase loan product p for the customer k;
$${W}_{loan 1 , k} = {w}_{loan 1} \times \frac{d {R}_{loan 1}}{d {P}_{loan 1}} \times {\partial }_{loan 1 , k} ;$$
Wₗₒₐₙ₁ is a non-price value of the first financial institution;
$$\frac{d {R}_{loan 1}}{d {P}_{loan 1}}$$
is the rate at which points paid can buy down the rate Rₗₒₐₙ₁ of the first purchase loan product;
∂_{loan1,k}=0 if Cₖ(DTI_{max,k})<Cₖ(Rₗₒₐₙ₁);
∂_{loan1,k}=0 if customer k is ineligible for the first purchase loan product;
∂_{loan1,k}=1 otherwise;
$${W}_{p , k} = {w}_{p} \times \frac{d {R}_{p}}{d {P}_{p}} \times {\partial }_{p , k} ;$$
wₚ is a non-price value of the financial institution offering the competing purchase loan product p;
$$\frac{d {R}_{p}}{d {P}_{p}}$$
is the rate at which points paid can buy down the rate Rₚ of the competing purchase loan product p;
∂_{p,k}=0 if Cₖ(DTIₘₐₓ)<Cₖ(Rₗₒₐₙ₁);
∂_{p,k}=0 if customer k is ineligible for a competing purchase loan product p;
∂_{p,k}=1 otherwise.

11. The computer program product according to claim 10, wherein the non-transitory computer-readable storage medium has computer-executable instructions for:
assigning a value for the non-price value wₗₒₐₙ₁ of the first financial institution; and
determining the non-price value wₚ of each financial institution offering each competing purchase loan product by applying the demand volume model to historical volume data for purchase loan products at each financial institution offering each competing purchase loan product to determine a value for the non-price value wₚ of each financial institution offering each competing purchase loan product that best fits the historical volume data for purchase loan products at each financial institution offering each competing purchase loan product.

12. The computer program product according to claim 10, wherein the non-transitory computer-readable storage medium has computer-executable instructions for predicting the demand volume of first purchase loan product at each of a plurality of different interest rates by calculating the demand volume of the first purchase loan product at each of the plurality of different interest rates using the demand volume model.

13. A method of predicting the demand of a first purchase loan product provided by a first financial institution, comprising:
storing, with a computer processor, a plurality of customer profiles reflecting a plurality of hypothetical shopping customers, the hypothetical customers reflecting the makeup of customers expected to be shopping for purchase loan products during a predetermined period of time, each customer profile including a maximum acceptable debit-to-income ratio DTI_{max,k} of a hypothetical shopping customer k and a maximum acceptable monthly payment Cₖ(DTI_{max,k}) reflecting the maximum acceptable monthly payment of the hypothetical customer k;
storing, with a computer processor, a plurality of competing purchase loan product profiles reflecting a plurality of hypothetical competing purchase loan products expected to be available during the predetermined period of time, each competing purchase loan product profile including a rate Rₚ reflecting a loan rate of a competing purchase loan product p;
storing, with a computer processor, a plurality of rules for determining how each hypothetical shopping customer makes a purchase loan decision, the rules comprising rules for determining if each hypothetical shopping customer decides to purchase a purchase loan product and rules for determining which purchase loan product each hypothetical shopping customer decides to purchase from the first purchase loan product and the hypothetical competing purchase loan products;
predicting, with a computer processor, the demand volume of shopping customers for the first purchase loan product during the predetermined period of time by simulating the purchase loan decision of each hypothetical shopping customer;
predicting, with a computer processor, the demand volume of non-shopping customers for the first purchase loan product during the predetermined period of time;
predicting, with a computer processor, the demand volume Vₗₒₐₙ₁ of the first purchase loan product being offered at an interest rate of Rₗₒₐₙ₁, wherein the demand volume of the first purchase loan product is equal to the sum of the predicted demand volume for the first purchase loan product from non-shopping customers during the predetermined period of time and the predicted demand volume of shopping customers for the first purchase loan product during the predetermined period of time.

14. The method according to claim 13, wherein the hypothetical competing purchase loan products comprise a second purchase loan product provided by the first financial institution.

15. The method according to claim 13, wherein predicting the demand volume of non-shopping customers for the first purchase loan product during the predetermined period of time is based upon analyzing historical volume data for purchase loan products to determine a historical ratio of a historical demand volume of non-shopping customers for purchase loan products to a historical total demand volume for purchase loan products.

16. The method according to claim 13, wherein predicting the demand volume Vₗₒₐₙ₁ of the first purchase loan product comprises calculating the demand volume Vₗₒₐₙ₁ using a demand volume model, the demand volume model defining:
$${V}_{loan 1} = {n}_{loan 1} + γ {\sum }_{k} \frac{{W}_{loan 1 , k} \times ( {C}_{k} ( {DTI}_{max , k} ) - {C}_{k} ( {R}_{loan 1} ) )}{\begin{matrix}{W}_{loan 1 , k} \times ( {C}_{k} ( {DTI}_{max , k} ) - {C}_{k} ( {R}_{loan 1} ) ) + \\ {\sum }_{l} {W}_{p , k} \times ( {C}_{k} ( {DTI}_{max , k} ) - {C}_{k} ( {R}_{p} ) )\end{matrix}} ;$$
nₗₒₐₙ₁ is the predicted demand volume for the first purchase loan product from non-shopping customers during the predetermined period of time;
γ is the ratio of the total number of expected shopping customers over the total number of hypothetical shopping customers;
Rₗₒₐₙ₁ is the loan rate of the first purchase loan product;
Cₖ(Rₗₒₐₙ₁) is the expected monthly loan payment of the first purchase loan product for the customer k;
Cₖ(Rₚ) is the expected monthly loan payment of the competing purchase loan product p for the customer k;
$${W}_{loan 1 , k} = {w}_{loan 1} \times \frac{d {R}_{loan 1}}{d {P}_{loan 1}} \times {\partial }_{loan 1 , k} ;$$
wₗₒₐₙ₁ is a non-price value of the first financial institution;
$$\frac{d {R}_{loan 1}}{d {P}_{loan 1}}$$
is the rate at which points paid can buy down the rate Rₗₒₐₙ₁ of the first purchase loan product;
∂_{loan1,k}=0 if Cₖ(DTI_{max,k})<Cₖ(Rₗₒₐₙ₁);
∂_{loan1,k}=0 if customer k is ineligible for the first purchase loan product;
∂_{loan1,k}=1 otherwise;
$${W}_{p , k} = {w}_{p} \times \frac{d {R}_{p}}{d {P}_{p}} \times {\partial }_{p , k} ;$$
wₚ is a non-price value of the financial institution offering the competing purchase loan product p;
$$\frac{d {R}_{p}}{d {P}_{p}}$$
is the rate at which points paid can buy down the rate Rₚ of the competing purchase loan product p;
∂_{p,k}=0 if Cₖ(DTIₘₐₓ)<Cₖ(Rₗₒₐₙ₁);
∂_{p,k}=0 if customer k is ineligible for a competing purchase loan product p;
∂_{p,k}=1 otherwise.

17. The method according to claim 16, comprising:
assigning a value for the non-price value wₗₒₐₙ₁ of the first financial institution; and
determining the non-price value wₚ of each financial institution offering each competing purchase loan product by applying the demand volume model to historical volume data for purchase loan products at each financial institution offering each competing purchase loan product to determine a value for the non-price value wₚ of each financial institution offering each competing purchase loan product that best fits the historical volume data for purchase loan products at each financial institution offering each competing purchase loan product.

18. The method according to claim 16, comprising predicting the demand volume of first purchase loan product at each of a plurality of different interest rates by calculating the demand volume of the first purchase loan product at each of the plurality of different interest rates using the demand volume model.
